(19) United States
(12) Patent Application Publication
(10) Pub. No.: US 2025/0345705 A1
(43) Pub. Date: Nov. 13, 2025

(54) EXTERNAL CONTROLLER FOR HANDHELD DEVICE, AND OPERATING METHOD THEREOF

(71) Applicant: DEXIN CORPORATION, New Taipei City (TW)

(72) Inventor: HO-LUNG LU, NEW TAIPEI CITY (TW)

(21) Appl. No.: 18/957,834

(22) Filed: Nov. 24, 2024

Related U.S. Application Data
(60) Provisional application No. 63/644,592, filed on May 9, 2024.

(30) Foreign Application Priority Data
Aug. 6, 2024 (TW) 113129276

(51) Int. Cl. A63F 13/24; A63F 13/285; G06F 3/01; G06F 3/0338; G06F 3/038

(52) U.S. Cl. CPC A63F 13/24; A63F 13/285; G06F 3/016; G06F 3/0383; G06F 3/0338; G06F 2203/0384

(57) ABSTRACT

A handheld device external controller and an operating method thereof are provided. The handheld device external controller includes a first control part, a second control part, and a connection part that connects the first control part and the second control part, and the handheld device external controller is connected to an external host through a communication interface. In the operating method, a connection between the handheld device external controller and the external host is established to transmit a control signal generated by the user operating the handheld device external controller to the external host and to receive signals from the external host. Another connection between a handheld device mounted on the handheld device external controller and the external host is established to receive an image signal transmitted by the external host and to display image on a display of the handheld device.

### CROSS-REFERENCE TO RELATED PATENT APPLICATION

This application claims the benefit of priority to Taiwan Patent Application No. 113129276, filed on Aug. 6, 2024. The entire content of the above identified application is incorporated herein by reference.

This application claims the benefit of priority to the U.S. Provisional Patent Application Ser. No. 63/644,592, filed on May 9, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an external remote controller for a handheld device, and more particularly to a handheld device external controller and an operating method of the handheld device external controller for providing solutions for connection with an external host, control, and display.

### BACKGROUND OF THE DISCLOSURE

Mobile devices, such as mobile phones or tablets, not only provide functionalities relating to messaging, audio and video content, and handling of daily affairs, but also provide users with various interactive entertainment such as electronic games. Users generally play games by using a touchscreen of the mobile devices as an operating interface. For example, a touchscreen displays game content and displays virtual buttons or joysticks at convenient locations for fingers, thereby allowing the users to play games through a virtual control interface.

However, playing games through the virtual control interface provides a different handling experience from using a physical game controller. Therefore, certain companies have designed external controllers for gaming exclusively on mobile devices that are known as external game controllers, such that mobile devices can be plugged to the external game controllers. The external game controller establishes a wired or wireless connection with the mobile device and transmits game signals. Furthermore, the users can operate physical buttons or joysticks on the external game controller to play games.

### SUMMARY OF THE DISCLOSURE

In response to the above-referenced technical inadequacies, the present disclosure provides a handheld device external controller and an operating method of the handheld device external controller to provide an external controller that is more flexible than existing external controllers.

According to one embodiment of the handheld device external controller, the handheld device external controller includes a first control part, a second control part, and a connection part. Two ends of the connection part are connected to the first control part and the second control part by a connection mechanism and an electrical connection line, respectively. The handheld device external controller is further connected to an external host through a communication interface for transmitting a control signal generated according to a user operating the handheld device external controller to the external host. A handheld device is mounted on the handheld device external controller through a fixing structure of the connection part, and the handheld device external controller is connected to the handheld device via signals through a connection interface disposed on the first control part or the second control part.

In one of the possible or preferred embodiments, the handheld device external controller receives a feedback signal generated by the external host through the communication interface. For example, the feedback signal generated by the external host forms a sound or a vibration generated by the first control part and/or the second control part.

In one of the possible or preferred embodiments, an operation interface formed by a button group and a joystick is disposed on the first control part and the second control part, respectively, and the operation interface is operated by the user to generate a control signal that is transmitted to the external host.

In one of the possible or preferred embodiments, the handheld device mounted on the handheld device external controller is directly connected to the external host by using a wireless communication protocol to receive an image signal transmitted from the external host and displays an image on a display of the handheld device.

In one of the possible or preferred embodiments, an input signal generated by the user operating the handheld device is transmitted to the external host through the wireless communication protocol or the handheld device external controller. For example, a virtual input interface is initiated by the handheld device, and the user operates the virtual input interface to generate the input signal.

In another embodiment, a handheld device is mounted on the handheld device external controller through a fixing structure of the connection part, and the handheld device external controller is connected to the handheld device via signals through a connection interface. Furthermore, the handheld device is connected to an external host through a wireless communication protocol, so that a control signal generated according to a user operating the handheld device external controller is transmitted to the handheld device through the connection interface, and then transmitted to the external host through the wireless communication protocol.

In one of the possible or preferred embodiments, the handheld device receives a feedback signal generated by the external host through the wireless communication protocol, and then transmits the feedback signal to the handheld device external controller through the connection interface.

According to one embodiment of an operating method of the handheld device external controller, a connection (e.g., a first connection) between the handheld device external controller and the external host is established, and then a connection (e.g., a second connection) between the handheld device mounted on the handheld device external controller and the external host is established.

When the user operates the handheld device external controller to generate the control signal, the control signal can be transmitted to the external host through the first connection, and the feedback signal can be received through the first connection, so as to form a sound or a vibration generated by the first control part and/or the second control part.

Moreover, an image signal is transmitted from the external host through the second connection between the handheld device and the external host, and an image is displayed on a display of the handheld device. In the handheld device, a virtual input interface can be run in the handheld device according to the image that is displayed, and the user operates the virtual input interface to generate an input signal that is then transmitted to the external host.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of main components of a handheld device external controller according to one embodiment of the present disclosure;

FIG. 2 is a schematic diagram of the handheld device external controller being connected to a handheld device and an external host according to one embodiment of the present disclosure;

FIG. 3 is a schematic diagram of a connection structure between the handheld device external controller and the handheld device according to one embodiment of the present disclosure;

FIG. 4 is a schematic diagram of a circuitry and a connection relationship between the handheld device external controller, the handheld device, and the external host according to one embodiment of the present disclosure;

FIG. 5 is a flowchart of an operating method between the handheld device external controller, the handheld device, and the external host according to one embodiment of the present disclosure; and

FIG. 6 is another flowchart of the operating method between the handheld device external controller, the handheld device, and the external host according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a handheld device external controller and an operating method thereof. An external controller is connected to a handheld device through mechanical designs and connection means, thereby allowing a user to control the handheld device by using a physical controller to operate software in the handheld device. For example, an electronic game is executed in the handheld device, and the user uses an external controller to operate the electronic game. Furthermore, the handheld device external controller provided in the present disclosure can also be connected to an external host through wired or wireless communication means, such that the user can also operate the handheld device external controller to control the external host.

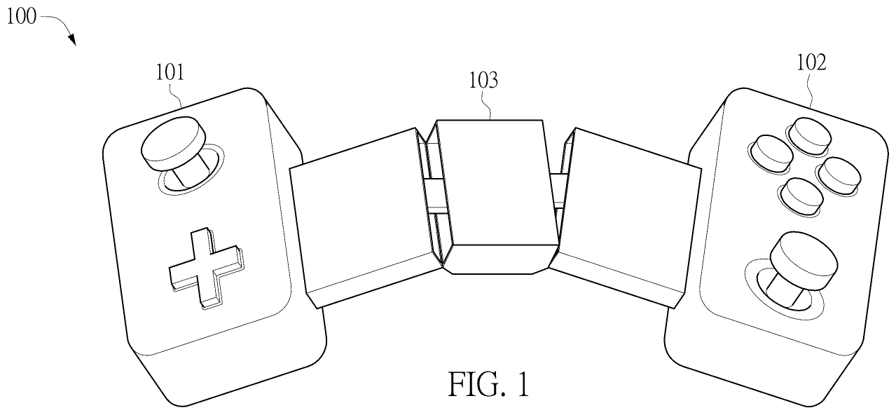

An appearance of the handheld device external controller can be referred to in the schematic diagram of the appearance of one embodiment as shown in FIG. 1, in which main components of the handheld device external controller mainly include a first control part 101 for left-hand operation and a second control part 102 for right-hand operation of the user. The first control part 101 and the second control part 102 are connected to each other by a connection part 103 through the design of a connection mechanism (e.g., a bridge mechanism), in which circuits and connection interfaces are also provided to be connected to each other.

The connection part 103 can be designed as a bendable hinge structure for convenient storage, and can be designed to have a telescopic mechanism such that handheld devices of various sizes (not shown in this figure) are fixed thereto, and a handle that can fix the handheld device can be disposed thereon. For example, portions in a left-right connection with the first control part 101 and the second control part 102 are respectively designed to have clamping structures that allow insertion of the handheld device.

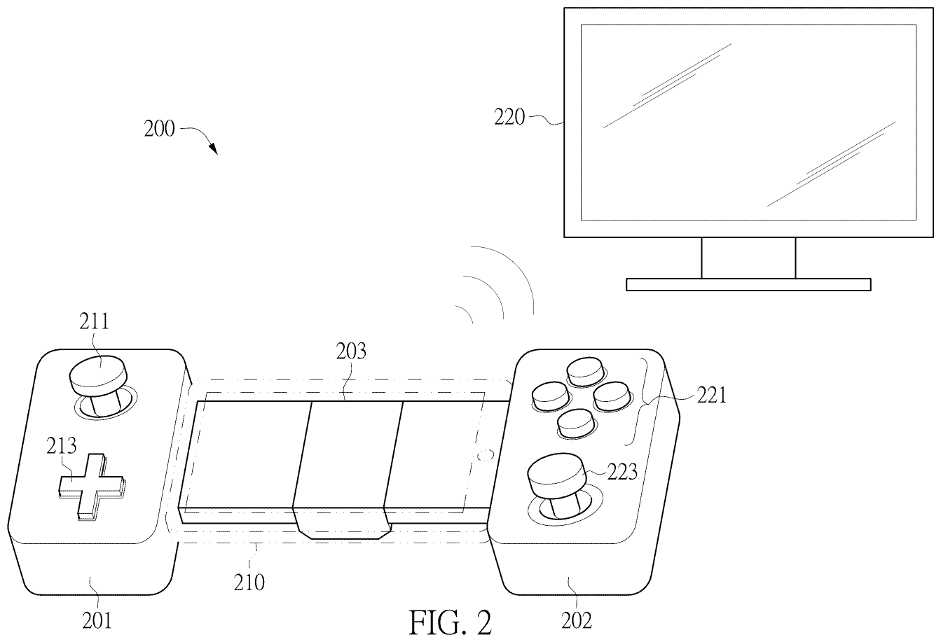

Furthermore, the handheld device external controller provided in the disclosure not only provides a technical solution to connect to the handheld device and operate a physical controller, but can also be connected to another external host for control, communication, and content transmission; details thereof can be referred to schematic diagram of the embodiment shown in FIG. 2.

FIG. 2 shows a handheld device external controller 200, in which the main components include a first control part 201 and a second control part 202 respectively provided for operation by the left and right hands of a user. According to this embodiment, the first control part 201 and the second control part 202 of the handheld device external controller 200 provide two handles for the left and right hands of the user to operate. The first control part 201, the second control part 202, and the connection part 203 can respectively be detachably assembled on two sides of a handheld device 210, so as to provide a structural design for the user to hold and operate the handheld device 210 on the handheld device external controller 200.

According to the example shown in the figure, the handheld device external controller 200 has an operation interface including buttons, knobs, and joysticks for the user to operate the handheld device external controller 200 and transmit control signals to the handheld device 210 through a communication interface. According to the figure, a first joystick 211 and a first button group 213 are disposed on the first control part 201, and relevant circuitry of these control interfaces are disposed inside the first control part 201; a second button group 221 and a second joystick 223 are disposed inside the second control part 202, and relevant circuitry of these physical control interfaces are disposed inside the second control part 202. In particular, the handheld device 210 is fixed on the connection part 203 between the first control part 201 and the second control part 202 by using a clamping structure. The handheld device external controller 200 can be connected with the handheld device 210 via wired connection (such as USB Type-C) and related connection interface. Alternatively, the handheld device external controller 200 is connected with the handheld device 210 through wireless communication (such as Bluetooth® communication).

According to one embodiment, the handheld device 210 can provide power to the handheld device external controller 200 through a communication interface. For example, the handheld device 210 has a universal serial bus (USB) or a connection interface of specific specifications to be electrically connected with a power management chip in the handheld device 210, so as to output the power in the handheld device 210 to the handheld device external controller 200 through a connection cable (such as a USB cable). Therefore, the handheld device external controller 200 can be operated by using the power supplied by the handheld device 210.

Further, according to one embodiment of the handheld device external controller 200, the wireless or wired communication circuits between the handheld device external controller 200 and the external host 220 are as follows. The connection means includes radio, Bluetooth® communication, wireless local area network (such as Wi-Fi®), or other IoT communication protocols. On the other hand, the handheld device 210 can also directly establish a connection with the external host 220, or the handheld device 210 can communicate with the external host 220 through the handheld device external controller 200.

According to one embodiment, the external host 220 is such as a television, a video game console, or a personal computer. In one embodiment, after the handheld device external controller 200 is connected to the external host 220, the user can operate the handheld device external controller 200 to control the operating system and applications that are run in the external host 220. In particular, since the handheld device external controller 200 provides an operating interface for electronic games, the user can operate the handheld device external controller 200 to play games that are run in the external host 220.

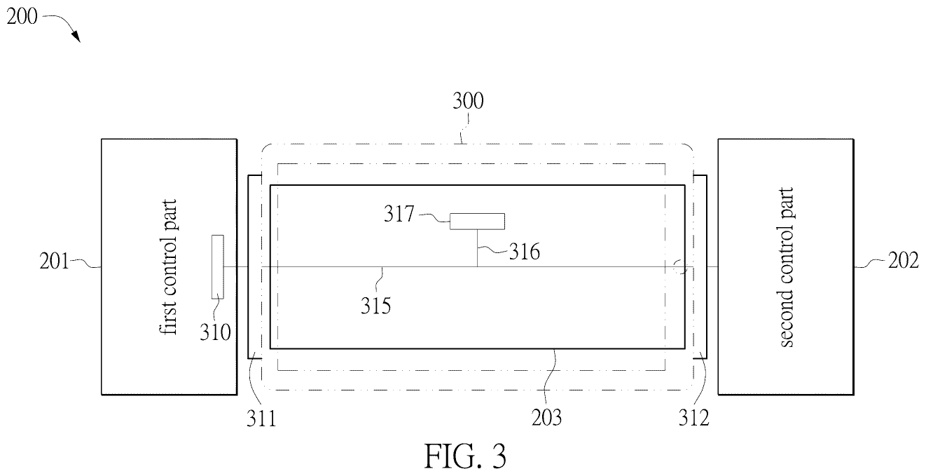

FIG. 3 further shows a schematic diagram of a connection structure between the handheld device external controller and the handheld device according to one embodiment.

The figure shows that the first control part 201 of the handheld device external controller 200 has a communication interface 310. It should be noted that, the communication interface 310 can be disposed at any position of the handheld device external controller 200. The function of the communication interface 310 is to establish a connection with an external host (not shown in this figure) through wired (such as USB) or wireless (such as radio, Bluetooth® communication, Wi-Fi®) communication methods.

The figure further shows that the first control part 201 of the handheld device external controller 200 has a first fixing structure 311, and the second control part 202 has a second fixing structure 312. The first fixing structure 311 and the second fixing structure 312 are used to clamp a handheld device 300 mounted on the connection part 203. In one embodiment, the first fixing structure 311 and the second fixing structure 312 have elastic connection mechanisms for more firmly fixing the handheld device 300 through such elastic mechanism.

The connection part 203 has circuits and electrical connection lines. For example, the handheld device external controller 200 can be connected to the handheld device 300 through an electrical connection line 316 and a connection interface 317. The first control part 201 and the second control part 202 are electrically connected to each other through an electrical connection line 315 disposed in the connection part 203 for transmitting control signals generated by the user operating the handheld device external controller 200 and transmitting a power signal provided by the by the handheld device 300.

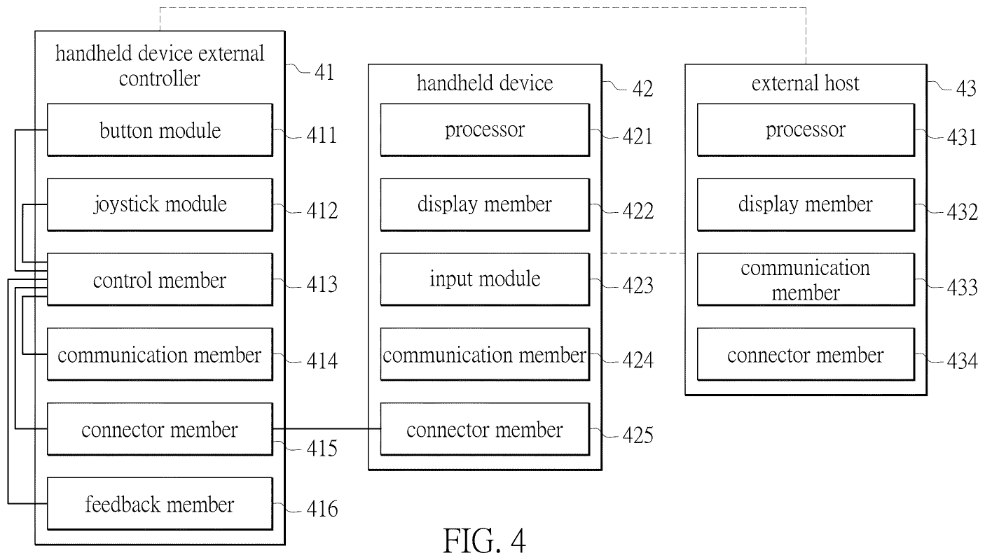

According to the handheld device external controller provided in the present disclosure, the operating mode may include operating the clamped handheld device, or operating a remote control to be directly connected to an external host for operation, or operating the clamped handheld device to control the external host, etc. For an operation between the handheld device external controller, the handheld device, and the external host, reference can be made to the schematic diagram of a connection relationship between the circuit modules and the device according to the device shown in FIG. 4.

A handheld device external controller 41 shown in FIG. 4 has a control member 413 for controlling the operation of the device, and relevant circuit components electrically connected to the control member 413 mainly include a button module 411, a joystick module 412, the control member 413, a communication member 414, a connector member 415, and a feedback member 416.

Referring to the embodiment shown in FIG. 2, the handheld device external controller 200 has a physical operation interface, such as the first joystick 211 and the first button group 213 disposed on the first control part 201, and the second button group 221 and the second joystick 223 disposed on the second control part 202. According to the embodiment, the button groups and joysticks that are respectively provided on the first control part 201 and the second control part 202 form the operation interface allowing the user to operate to generate control signals that are sent to the external host 220.

The button module 411 shown in FIG. 4 is the control circuit of the physical first button group 213 and the second button group 221. Instructions generated by the user operating the physical buttons are converted into control signals through the button module 411; the joystick module 412 is the control circuit of the physical first joystick 211 and the second joystick 223 and is used to process instructions generated by the user operating the physical joysticks.

The control signal generated through the button module 411 and the joystick module 412 is then processed by the control member 413 and transmitted to a handheld device 42 or an external host 43 via the communication member 414. The handheld device external controller 41 has the connector member 415 for being directly connected to the handheld device 42, so as to transmit the control signal and obtain power through the connector member 415.

The handheld device external controller 41 may also have the feedback member 416. The feedback member 416 may be various electronic components disposed in the handheld device external controller 41 and be able to respond to the control signals, such as vibrators, buzzers, speakers, and indicator lights. For example, when the user operates the handheld device external controller 41 to play a game, certain signals generated in the game can be fed back to the user through the feedback member 416 through vibrations, sounds, and light signals, and feedback information forms feedback such as vibrations, sounds, or light signals generated by the first control part 201 and/or the second control part 202.

The figure shows certain main circuit components in the handheld device 42, such as a processor 421 and a display member 422, an input module 423, a communication member 424, and a connector member 425 that are electrically connected to each other. The handheld device 42, such as a mobile phone or a tablet computer, can be clamped on the handheld device external controller 41, thereby allowing the user to control the game running on the handheld device 42 by operating the handheld device external controller 41. The display member 422 of the handheld device 42 displays an in-game image, and the input module 423 is implemented as a touchscreen of the handheld device 42 and uses software to initiate a virtual input interface.

The handheld device 42 has the communication member 424 that can be wirelessly connected to the external host 43 for transmitting and receiving signals. In one embodiment, the handheld device 42 can project the image that is displayed on the handheld device 42 to the external host 43 through the communication member 424; in another embodiment, the handheld device 42 can receive the picture provided by the external host 43 through the communication member 424. For example, an input interface that can be used for operating the electronic game running in the external host 43 is displayed on a touchscreen of the handheld device 42.

The external host 43, such as a television, a game console, or a computer host, has a processor 431 and electronic components electrically connected to each other, mainly such as a display member 432, a communication member 433, and a connector member 434. The display member 432 of the external host 43 generates a picture displayed on the display, and is connected to the handheld device external controller 41 through the communication member 433, or directly connected to the handheld device 42, thereby transmitting control signals and image signals. For example, the picture is transmitted to the handheld device 42 through this communication connection, such that the display of the handheld device 42 becomes the second screen of the external host 43. The external host 43 can be connected to the handheld device external controller 41 in a wired manner through the connector member 434.

It should be noted that, according to one embodiment, the software program running in the external host 43 provides an application programming interface (API) to establish the specifications of an external control software program, such that the handheld device external controller 41 and the handheld device 42 can use the application to achieve communication purposes with the external host 43 through the API, including controlling the running software program.

For example, the display of the external host 43 displays the image of an electronic game. This game image can be generated by a game program executed by the computer system of the external host 43, or can be to a picture displayed on the external host 43 projected by the handheld device 42 by using a specific communication protocol. According to the embodiment, a first connection between the handheld device external controller 41 and the external host 43 is first established, and then a second connection between the handheld device 42 mounted on the handheld device external controller 41 and the external host 43 is established. Afterwards, a variety of operating modes can be run, and two of the operating modes are listed below.

A first operating mode includes the following steps.

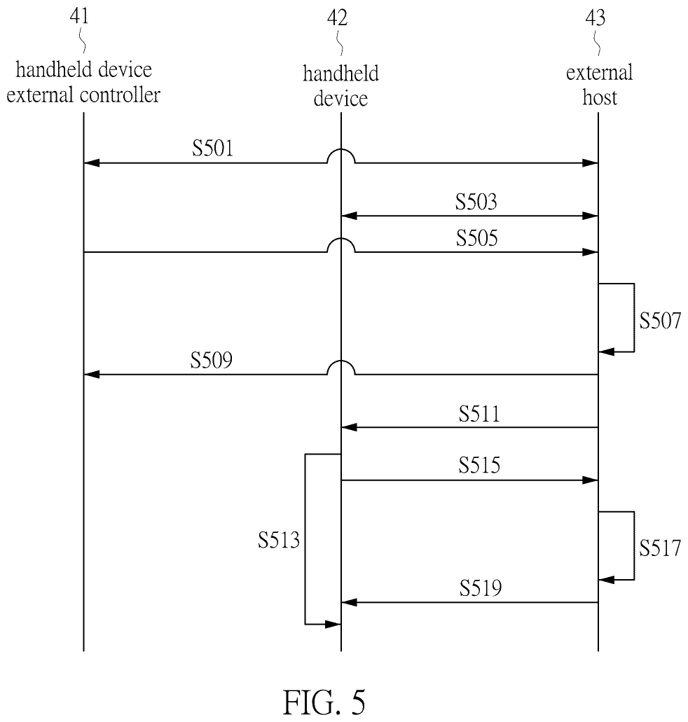

In the first operating mode, the handheld device external controller and the handheld device are respectively connected to the external host. The operating processes can be referred to in the flowchart of an operating method between the handheld device external controller 41, the handheld device 42, and the external host 43 shown in FIG. 5.

Firstly, the handheld device external controller 41 and the external host 43 establish a first connection through a specific channel and communication protocol (step S501). On the other hand, the handheld device 42 also establishes a second connection with the external host 43 through a specific channel and a wireless communication protocol (step S503).

The user operates the handheld device external controller 41 to control the software program running in the external host 43, and the control signal is transmitted through the first connection (step S505). The processor in the external host 43 processes the relevant instructions according to the control signal (step S507), generates a feedback signal that is fed back to the handheld device external controller 41, and feedback such as vibrations, sounds, or light signals can be generated in the handheld device external controller 41 (step S509). The above-mentioned steps are repeated during the operating process.

On the other hand, the handheld device 42 receives the image signal generated by the external host 43 through the second connection (step S511), displays the image through the touchscreen of the handheld device 42 (step S513), and allows the user to operate the touchscreen to control the external host 43 to generate an input signal sent to the external host 43 (step S515). After the input signal is processed by the external host 43 (step S517), the external host 43 also generates feedback signals corresponding to the input signals to the handheld device 42 (step S519). The above-mentioned steps are repeated during the operating process.

For example, when an electronic game is run in the external host 43, the user can operate the handheld device external controller 41 to play the game. In the duration of the game, control signals are continuously generated to the external host 43 through a first channel, and then the external host 43 returns a feedback signal to allow the user to feel the vibrations, sounds, or light signals generated by the handheld device external controller 41, thereby enhancing the gaming experience. On the other hand, the touchscreen of the handheld device 42 becomes the second screen for the game, the touchscreen displays the image transmitted by the external host 43, and the touchscreen can display a virtual input interface that allows the user to control the game with gestures or a virtual keyboard. Accordingly, relevant input signals are transmitted to the external host 43 through a second channel.

A second operating mode includes the following steps.

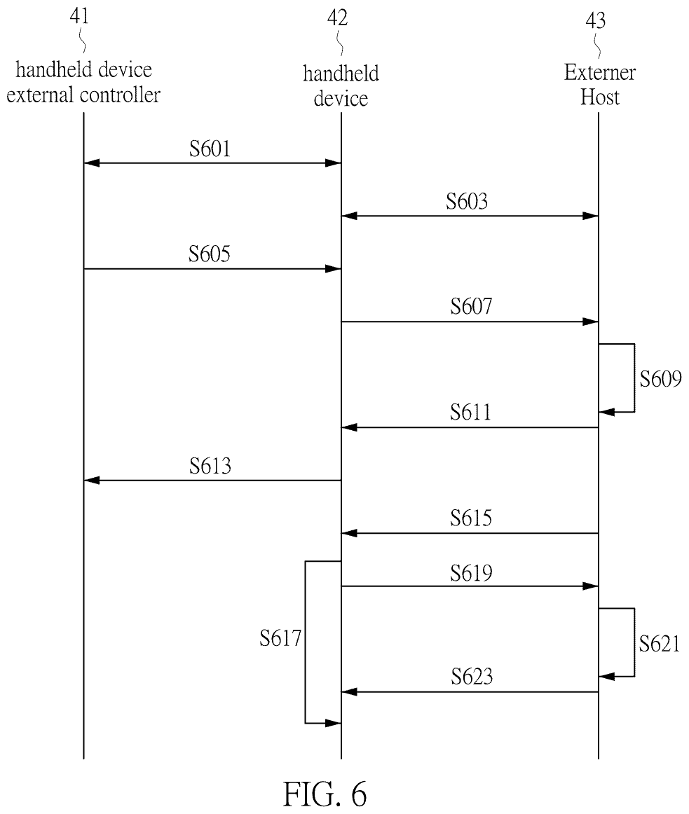

In the second operating mode, the handheld device 42 establishes a dedicated connection with the external host 43 through a specific channel and communication protocol. However, the handheld device external controller 41 does not directly connect to the external host 43, but first connects with the handheld device 42 through a specific channel and communication protocol. The handheld device external controller 41 then communicates with the external host 43 through the handheld device 42. As shown in FIG. 6, FIG. 6 is a flowchart of one embodiment of an operating method between the handheld device external controller 41, the handheld device 42, and the external host 43.

According to the process shown in the figure, a software program, such as an electronic game, is run in the external host 43. The handheld device external controller 41 establishes a first connection with the handheld device 42 (step S601). The handheld device 42 also establishes a second connection with the external host 43 through a wireless communication protocol (step S603). The user operates the handheld device external controller 41 to generate a control signal for operating the software program in the external host 43 and transmits the control signal to the handheld device 42 (step S605). The handheld device 42 then forwards the control signal to the external host 43 (step S607).

The instructions in the control signal that is received are processed by the external host 43 (step S609), and a corresponding feedback signal is generated. The feedback signal is first transmitted to the handheld device 42 through the second connection (step S611), and then transmitted to the handheld device external controller 41. Accordingly, corresponding vibrations, sounds, and/or light signals can be generated in the handheld device external controller 41 (step S613). The above-mentioned steps are repeated during the operating process.

On the other hand, the handheld device 42 can simultaneously receive the image signal transmitted by the external host 43 (step S615), and display the image on the touchscreen of the handheld device 42 (step S617). Taking a game as an example, the handheld device 42 displays contents of the second screen of the game running in the external host 43. Similarly, the handheld device 42 displays a virtual input interface, thereby allowing the user to control the software program that is run in the external host 43 through touch gestures, such that the input signal is send to the external host 43 (step S619). After the input signal is processed by the external host 43 (step S621), a feedback signal is generated to be sent to the handheld device 42 (step S623), which may generate feedback such as vibrations, sounds, and/or light signals on the handheld device 42.

In conclusion, according to the handheld device external controller and the operating method described in the above-mentioned embodiments, the handheld device external controller is designed to clamp the handheld device and establish a connection with the handheld device. On the other hand, the handheld device external controller further establishes a direct or indirect connection with an external host, thereby allowing the user to operate the handheld device external controller to control the software program in the handheld device, or to control the software program in the external host, thereby flexibly providing a variety of operating modes.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A handheld device external controller, comprising:
a first control part;
a second control part; and
a connection part, wherein two ends of the connection part are connected to the first control part and the second control part by a connection mechanism and an electrical connection line, respectively;
wherein the handheld device external controller is connected to an external host through a communication interface for transmitting a control signal generated according to a user operating the handheld device external controller to the external host; wherein a handheld device is mounted on the handheld device external controller through a fixing structure of the connection part, and the handheld device external controller is connected to the handheld device via signals through a connection interface disposed on the first control part or the second control part.

2. The handheld device external controller according to claim 1, wherein the handheld device external controller receives a feedback signal generated by the external host through the communication interface.

3. The handheld device external controller according to claim 2, wherein the feedback signal generated by the external host forms a sound or a vibration generated by the first control part and/or the second control part.

4. The handheld device external controller according to claim 1, wherein an operation interface formed by a button group and a joystick is disposed on the first control part and the second control part, respectively, and the operation interface is operated by the user to generate a control signal that is transmitted to the external host.

5. The handheld device external controller according to claim 1, wherein the handheld device mounted on the handheld device external controller is directly connected to the external host by using a wireless communication protocol to receive an image signal transmitted from the external host and displays an image on a display of the handheld device.

6. The handheld device external controller according to claim 5, wherein an input signal generated by the user operating the handheld device is transmitted to the external host through the wireless communication protocol or the handheld device external controller.

7. The handheld device external controller according to claim 6, wherein a virtual input interface is run in the handheld device according to the image that is displayed, and the user operates the virtual input interface to generate the input signal.

8. A handheld device external controller, comprising:
a first control part;
a second control part; and
a connection part, wherein two ends of the connection part are connected to the first control part and the second control part by a connection mechanism and an electrical connection line, respectively;
wherein a handheld device is mounted on the handheld device external controller through a fixing structure of the connection part, and the handheld device external controller is connected to the handheld device via signals through a connection interface disposed on the first control part or the second control part; wherein the handheld device is connected to an external host through a wireless communication protocol, so that a control signal generated according to a user operating the handheld device external controller is transmitted to the handheld device through the connection interface, and then transmitted to the external host through the wireless communication protocol.

9. The handheld device external controller according to claim 8, wherein the handheld device receives a feedback signal generated by the external host through the wireless communication protocol, and then transmits the feedback signal to the handheld device external controller through the connection interface.

10. The handheld device external controller according to claim 9, wherein the feedback signal generated by the external host forms a sound or a vibration generated by the first control part and/or the second control part.

11. The handheld device external controller according to claim 8, wherein an operation interface formed by a button group and a joystick is disposed on the first control part and the second control part, respectively, and the operation interface is operated by the user to generate a control signal that is transmitted to the external host.

12. The handheld device external controller according to claim 8, wherein the handheld device mounted on the handheld device external controller is directly connected to the external host to receive an image signal transmitted from the external host via the wireless communication protocol, and displays an image on a display of the handheld device.

13. The handheld device external controller according to claim 12, wherein an input signal generated by the user operating the handheld device is transmitted to the external host through the wireless communication protocol.

14. The handheld device external controller according to claim 13, wherein a virtual input interface is run in the handheld device according to the displayed image, and the user is provided to operate the virtual input interface to generate the input signal.

15. An operating method of the handheld device external controller as claimed in claim 1, including:
establishing a connection between the handheld device external controller and the external host, and establishing a connection between the handheld device mounted on the handheld device external controller and the external host;
generating the control signal according to the user operating the handheld device external controller;
transmitting the control signal to the external host;
receiving a feedback signal generated by the external host to form a sound or a vibration generated by the first control part and/or the second control part;
receiving an image signal transmitted from the external host through the connection between the handheld device and the external host, and displaying an image on a display of the handheld device; and
running a virtual input interface in the handheld device according to the image that is displayed, wherein the user operates the virtual input interface to generate an input signal that is then transmitted to the external host.

16. The operating method according to claim 15, wherein the handheld device mounted on the handheld device external controller is directly connected to the external host by using a wireless communication protocol to receive the image signal transmitted from the external host and displays the image on a display of the handheld device; wherein the input signal generated by the user operating the handheld device is transmitted to the external host through the wireless communication protocol or through the handheld device external controller.

17. The operating method according to claim 16, wherein the virtual input interface is run in the handheld device according to the image that is displayed, and the user operates the virtual input interface to generate the input signal.

18. An operating method the handheld device external controller as claimed in claim 8, including:
establishing a connection between the handheld device external controller and the external host, and establishing a connection between the handheld device mounted on the handheld device external controller and the external host;
generating the control signal according to the user operating the handheld device external controller;
transmitting the control signal to the external host;
receiving a feedback signal generated by the external host to form a sound or a vibration generated by the first control part and/or the second control part;
receiving an image signal transmitted from the external host through the connection between the handheld device and the external host, and displaying an image on a display of the handheld device; and
running a virtual input interface in the handheld device according to the image that is displayed, wherein the user operates the virtual input interface to generate an input signal that is then transmitted to the external host.

19. The operating method according to claim 18, wherein the handheld device mounted on the handheld device external controller receives the image signal transmitted from the external host through the wireless communication protocol, and displays the image on the display of the handheld device; wherein the input signal generated by the user operating the handheld device is transmitted to the external host through the wireless communication protocol.

20. The operating method according to claim 19, wherein the virtual input interface is run in the handheld device according to the image that is displayed, and the user is able to operate the virtual input interface to generate the input signal.
